(19) United States
(12) Patent Application Publication
(10) Pub. No.: US 2023/0403072 A1
(43) Pub. Date: Dec. 14, 2023

(54) MULTI-CONSTELLATION TRANSCEIVER

(71) Applicant: KYMETA CORPORATION, Redmond, WA (US)

(72) Inventors: Turner NOEL, Kirkland, WA (US); Alex Schnedler, Seattle, WA (US); Maxwell A. Smoot, Redmond, WA (US)

(21) Appl. No.: 18/209,391

(22) Filed: Jun. 13, 2023

Related U.S. Application Data
(60) Provisional application No. 63/352,170, filed on Jun. 14, 2022.

(51) Int. Cl. H04B 7/185

(52) U.S. Cl. CPC H04B 7/18563; H04B 7/18515

(57) ABSTRACT

A multi-constellation transceiver, a satellite terminal containing the same, and a method using the same are disclosed. In some embodiments, the satellite terminal includes an antenna, a common port coupled to the antenna, and a plurality of modems to be switched into and out of use in real-time, via software commands, to allow transitioning between networks via software commands, each of the modems associated with a different satellite constellation. The satellite terminal also includes a multi-constellation transceiver, communicably coupled to the antenna via the common port and to the plurality of modems, to route signals between the antenna and individual modems of the plurality of modems.

### RELATED APPLICATION

The present application is a non-provisional application of and claims the benefit of U.S. Provisional Patent Application No. 63/352,170, filed Jun. 14, 2022, and entitled “Multi-Constellation Transceiver”, which is incorporated by reference in its entirety.

### FIELD OF THE DISCLOSURE

Embodiments disclosed herein are related to wireless communication; more particularly, embodiments disclosed herein relate to a multi-constellation transceiver that can be used in a satellite terminal.

### BACKGROUND

Metasurface antennas have recently emerged as a new technology for generating steered, directive beams from a lightweight, low-cost, and planar physical platform. Such metasurface antennas have been recently used in a number of applications, such as, for example, satellite communication.

Metasurface antennas may be used with a variety of modems. In the prior art, antennas are typically designed to operate with one network. Therefore, the antenna needs to operate with a modem that works with that one network. For example, parabolic antennas usually operate with one network and only one modem. Therefore, such antennas are not designed to support multiple modems and thus not designed to switch between the use of different modems without significant intervention. Because such antennas do not switch between the use of two different modems, they do not switch between different polarizations such as the different polarizations used in GEO and LEO constellations. In other words, as a LEO modem typically uses circular polarization and a GEO modem typically uses linear polarization, such antennas do not switch between linear and circular polarization since they don't switch between using a LEO modem and a GEO modem.

### SUMMARY

A multi-constellation transceiver, a satellite terminal containing the same, and a method using the same are disclosed. In some embodiments, the satellite terminal includes an antenna, a common port coupled to the antenna, and a plurality of modems to be switched into and out of use in real-time, via software commands, to allow transitioning between networks via software commands, each of the modems associated with a different satellite constellation. The satellite terminal also includes a multi-constellation transceiver, communicably coupled to the antenna via the common port and to the plurality of modems, to route signals between the antenna and individual modems of the plurality of modems.

In some other embodiments, the satellite terminal includes an antenna, a common port coupled to the antenna, and a plurality of modems to be switched into and out of use in real-time to allow transitioning between networks via software commands, each of the modems associated with a different satellite constellation, wherein the plurality of modems comprises at least one LEO modem and at least one CEO modem. The satellite terminal also includes a multi-constellation transceiver, communicably coupled to the antenna via the common port and to the plurality of modems, to route signals between the antenna and to one modem of the plurality of modems, where the multi-constellation transceiver includes: a radio-frequency (RF) chain, and an interface coupled to the RF chain via at least one communication cable, the interface configured to perform multiplexing and demultiplexing operations between the single communication cable and the plurality of modems.

In some embodiments, the method includes routing signals between an antenna and individual modems of the plurality of modems an antenna by receiving signal from the antenna via a common port and directing those signals to one of the plurality of modems using a multi-constellation transceiver, communicably coupled to the antenna via the common port and to the plurality of modems, and sending transmit signals, using the multi-constellation transceiver received from the plurality of modems to the antenna via the signal common port, including switching into and out of use of the plurality of modems in real-time, via software commands, to allow transitioning between networks via software commands, each of the modems associated with a different satellite constellation.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 illustrates an exploded view of some embodiments of a flat-panel antenna.

FIG. 2 illustrates an example of a communication system that includes one or more antennas described herein.

FIG. 3 illustrates some embodiments of a satellite antenna terminal having a multi-constellation transceiver.

FIG. 4 illustrates some embodiments of the satellite terminal of FIG. 3.

FIG. 5 illustrates some embodiments of a multi-constellation transceiver of a satellite terminal having an antenna.

FIG. 6 illustrates some embodiments of a fully-enclosed three modem transceiver.

FIG. 7 illustrates some embodiments of a multi-constellation transceiver using a single cable with two ports to replace the six external ports of FIG. 6.

FIG. 8 illustrates some embodiments of the RF chain and the interface board that are coupled together via the single cable as shown in FIG. 7.

FIG. 9 illustrates some embodiments of the RF chain and the interface board that are coupled together via three cables (e.g., coax cables).

### DETAILED DESCRIPTION

In the following description, numerous details are set forth to provide a more thorough explanation of embodiments of the present disclosure. It will be apparent, however, to one skilled in the art, that the teachings disclosed herein may be practiced without these specific details. In other instances, well-known structures and devices are shown in block diagram form, rather than in detail, in order to avoid obscuring the present disclosure.

Embodiments described herein include a multi-constellation transceiver and method for using the same. In some embodiments, multiple modems of the multi-constellation transceiver operate within a single satellite terminal environment. In some embodiments, the multiple modems include one or more of a Low Earth Orbit (LEO) modem, a Medium Earth Orbit (MEO) modem, and a Geosynchronous Equatorial Orbit (GEO) modem, though the techniques described herein are not limited to those types of modems. In some embodiments, each of the modems can be switched into and out of use in real-time, without the intervention of a customer or a trained professional to switch out hardware or other interaction from an outside user. Embodiments described herein allow a satellite terminal to switch between any LEO/MEO/GEO modems that use the conventional frequency band of the antenna common port. When the handover is done correctly with beam-forming, the downtime between network switching could be as quick as the new modem start-up acquisition time or the switching speed of physical switches. In some embodiments, this is done by leveraging commands via the antenna to the multi-constellation transceiver to route the signal to the desired modem. Such embodiments allow for a satellite terminal designed to satisfy multiple use cases via multiple modems that can offer unique waveforms, symbol rate limits, etc.

In some embodiments, the multi-constellation transceiver has a radio-frequency (RF) chain that is shared among the multiple modems. Embodiments described herein also include an integrated uplink power control solution and/or a reduction of cables and connectors, etc.

The following disclosure discusses examples of antenna embodiments followed by a description of multi-constellation transceiver embodiments that operate with antennas such as, for example, those described below.

### Examples of Antenna Embodiments

The techniques described herein may be used with a variety of flat panel satellite antennas. Embodiments of such flat panel antennas are disclosed herein. In some embodiments, the flat panel satellite antennas are part of a satellite terminal. The flat panel antennas include one or more arrays of antenna elements on an antenna aperture.

In some embodiments, the antenna aperture is a metasurface antenna aperture, such as, for example, the antenna apertures described below. In some embodiments, the antenna elements comprise radio-frequency (RF) radiating antenna elements. In some embodiments, the antenna elements include tunable devices to tune the antenna elements. Examples of such tunable devices include diodes and varactors such as, for example, described in U.S. Pat. No. 11,489,266, entitled “Metasurface Antennas Manufactured with Mass Transfer Technologies,” issued Nov. 1, 2022. In some other embodiments, the antenna elements comprise liquid crystal (LC)-based antenna elements, such as, for example, those disclosed in U.S. Pat. No. 9,887,456, entitled “Dynamic Polarization and Coupling Control from a Steerable Cylindrically Fed Holographic Antenna”, issued Feb. 6, 2018, or other RF radiating antenna elements. It should be appreciated that other tunable devices such as, for example, but not limited to, tunable capacitors, tunable capacitance dies, packaged dies, micro-electromechanical systems (MEMS) devices, or other tunable capacitance devices, could be placed into an antenna aperture or elsewhere in variations on the embodiments described herein.

In some embodiments, the antenna aperture having one or more arrays of antenna elements is comprised of multiple segments that are coupled together. In some embodiments, when coupled together, the combination of the segments form groups of antenna elements (e.g., closed rings of antenna elements concentric with respect to the antenna feed, etc.). For more information on antenna segments, see U.S. Pat. No. 9,887,455, entitled “Aperture Segmentation of a Cylindrical Feed Antenna”, issued Feb. 6, 2018.

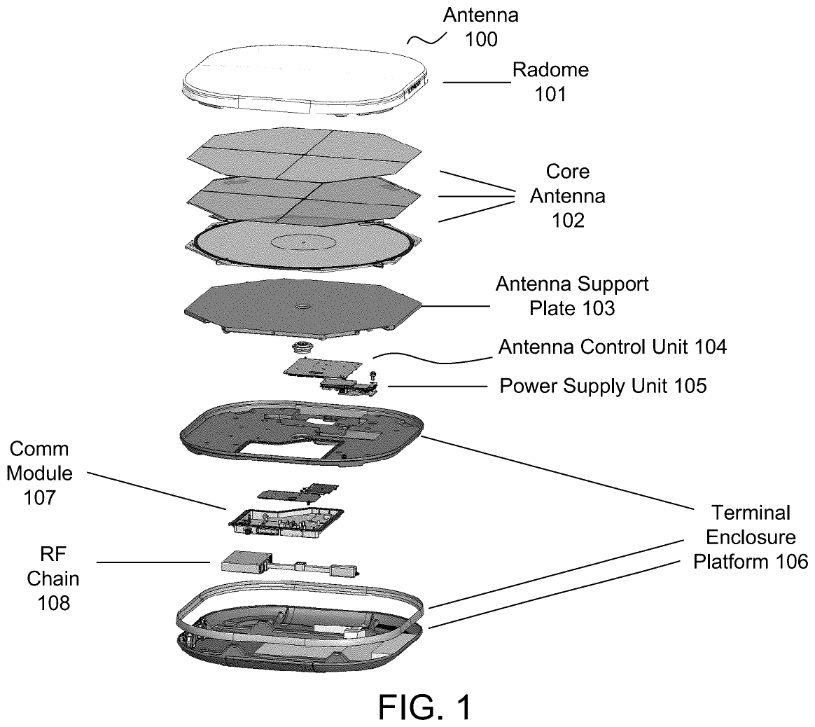

FIG. 1 illustrates an exploded view of some embodiments of a flat-panel antenna. Referring to FIG. 1, antenna 100 comprises a radome 101, a core antenna 102, antenna support plate 103, antenna control unit (ACU) 104, a power supply unit 105, terminal enclosure platform 106, comm (communication) module 107, and RF chain 108.

Radome 101 is the top portion of an enclosure that encloses core antenna 102. In some embodiments, radome 101 is weatherproof and is constructed of material transparent to radio waves to enable beams generated by core antenna 102 to extend to the exterior of radome 101.

In some embodiments, core antenna 102 comprises an aperture having RF radiating antenna elements. These antenna elements act as radiators (or slot radiators). In some embodiments, the antenna elements comprise scattering metamaterial antenna elements. In some embodiments, the antenna elements comprise both Receive (Rx) and Transmit (Tx) irises, or slots, that are interleaved and distributed on the whole surface of the antenna aperture of core antenna 102. Such Rx and Tx irises may be in groups of two or more sets where each set is for a separately and simultaneously controlled band. Examples of such antenna elements with irises are described in U.S. Pat. No. 10,892,553, entitled “Broad Tunable Bandwidth Radial Line Slot Antenna”, issued Jan. 12, 2021.

In some embodiments, the antenna elements comprise irises (iris openings) and the aperture antenna is used to generate a main beam shaped by using excitation from a cylindrical feed wave for radiating the iris openings through tunable elements (e.g., diodes, varactors, patch, etc.). In some embodiments, the antenna elements can be excited to radiate a horizontally or vertically polarized electric field at desired scan angles.

In some embodiments, a tunable element (e.g., diode, varactor, patch etc.) is located over each iris slot. The amount of radiated power from each antenna element is controlled by applying a voltage to the tunable element using a controller in ACU 104. Traces in core antenna 102 to each tunable element are used to provide the voltage to the tunable element. The voltage tunes or detunes the capacitance and thus the resonance frequency of individual elements to effectuate beam forming. The voltage required is dependent on the tunable element in use. Using this property, in some embodiments, the tunable element (e.g., diode, varactor, LC, etc.) integrates an on/off switch for the transmission of energy from a feed wave to the antenna element. When switched on, an antenna element emits an electromagnetic wave like an electrically small dipole antenna. Note that the teachings herein are not limited to having unit cell that operates in a binary fashion with respect to energy transmission. For example, in some embodiments in which varactors are the tunable element, there are 32 tuning levels. As another example, in some embodiments in which LC is the tunable element, there are 16 tuning levels.

A voltage between the tunable element and the slot can be modulated to tune the antenna element (e.g., the tunable resonator/slot). Adjusting the voltage varies the capacitance of a slot (e.g., the tunable resonator/slot). Accordingly, the reactance of a slot (e.g., the tunable resonator/slot) can be varied by changing the capacitance. Resonant frequency of the slot also changes according to the equation

$$f = \frac{1}{2 π \sqrt{LC}}$$

where f is the resonant frequency of the slot and L and C are the inductance and capacitance of the slot, respectively. The resonant frequency of the slot affects the energy coupled from a feed wave propagating through the waveguide to the antenna elements.

In particular, the generation of a focused beam by the metamaterial array of antenna elements can be explained by the phenomenon of constructive and destructive interference, which is well known in the art. Individual electromagnetic waves sum up (constructive interference) if they have the same phase when they meet in free space to create a beam, and waves cancel each other (destructive interference) if they are in opposite phase when they meet in free space. If the slots in core antenna 102 are positioned so that each successive slot is positioned at a different distance from the excitation point of the feed wave, the scattered wave from that antenna element will have a different phase than the scattered wave of the previous slot. In some embodiments, if the slots are spaced one quarter of a wavelength apart, each slot will scatter a wave with a one fourth phase delay from the previous slot. In some embodiments, by controlling which antenna elements are turned on or off (i.e., by changing the pattern of which antenna elements are turned on and which antenna elements are turned off) or which of the multiple tuning levels is used, a different pattern of constructive and destructive interference can be produced, and the antenna can change the direction of its beam(s).

In some embodiments, core antenna 102 includes a coaxial feed that is used to provide a cylindrical wave feed via an input feed, such as, for example, described in U.S. Pat. No. 9,887,456, entitled “Dynamic Polarization and Coupling Control from a Steerable Cylindrically Fed Holographic Antenna”, issued Feb. 6, 2018 or in U.S. Pat. No. 11,489,266, entitled “Metasurface Antennas Manufactured with Mass Transfer Technologies,” issued Nov. 1, 2022. In some embodiments, the cylindrical wave feed feeds core antenna 102 from a central point with an excitation that spreads outward in a cylindrical manner from the feed point. In other words, the cylindrically fed wave is an outward travelling concentric feed wave. Even so, the shape of the cylindrical feed antenna around the cylindrical feed can be circular, square or any shape. In some other embodiments, a cylindrically fed antenna aperture creates an inward travelling feed wave. In such a case, the feed wave most naturally comes from a circular structure.

In some embodiments, the core antenna comprises multiple layers. These layers include the one or more substrate layers forming the RF radiating antenna elements. In some embodiments, these layers may also include impedance matching layers (e.g., a wide-angle impedance matching (WAIM) layer, etc.), one or more spacer layers and/or dielectric layers. Such layers are well-known in the art.

Antenna support plate 103 is coupled to core antenna 102 to provide support for core antenna 102. In some embodiments, antenna support plate 103 includes one or more waveguides and one or more antenna feeds to provide one or more feed waves to core antenna 102 for use by antenna elements of core antenna 102 to generate one or more beams.

ACU 104 is coupled to antenna support plate 103 and provides controls for antenna 100. In some embodiments, these controls include controls for drive electronics for antenna 100 and a matrix drive circuitry to control a switching array interspersed throughout the array of RF radiating antenna elements. In some embodiments, the matrix drive circuitry uses unique addresses to apply voltages onto the tunable elements of the antenna elements to drive each antenna element separately from the other antenna elements. In some embodiments, the drive electronics for ACU 104 comprise commercial off-the shelf LCD controls used in commercial television appliances that adjust the voltage for each antenna element.

More specifically, in some embodiments, ACU 104 supplies an array of voltage signals to the tunable devices of the antenna elements to create a modulation, or control, pattern. The control pattern causes the elements to be tuned to different states. In some embodiments, ACU 104 uses the control pattern to control which antenna elements are turned on or off (or which of the tuning levels is used) and at which phase and amplitude level at the frequency of operation. The elements are selectively detuned for frequency operation by voltage application. In some embodiments, multistate control is used in which various elements are turned on and off to varying levels, further approximating a sinusoidal control pattern, as opposed to a square wave (i.e., a sinusoid gray shade modulation pattern).

In some embodiments, ACU 104 also contains one or more processors executing the software to perform some of the control operations. ACU 104 may control one or more sensors (e.g., a GPS receiver, a three-axis compass, a 3-axis accelerometer, 3-axis gyro, 3-axis magnetometer, etc.) to provide location and orientation information to the processor(s). The location and orientation information may be provided to the processor(s) by other systems in the earth station and/or may not be part of the antenna system.

Antenna 100 also includes a comm (communication) module 107 and an RF chain 108. Comm module 107 includes one or more modems enabling antenna 100 to communicate with various satellites and/or cellular systems, in addition to a router that selects the appropriate network route based on metrics (e.g., quality of service (QoS) metrics, e.g., signal strength, latency, etc.). RF chain 108 converts analog RF signals to digital form. In some embodiments, RF chain 108 comprises electronic components that may include amplifiers, filters, mixers, attenuators, and detectors.

Antenna 100 also includes power supply unit 105 to provide power to various subsystems or parts of antenna 100.

Antenna 100 also includes terminal enclosure platform 106 that forms the enclosure for the bottom of antenna 100. In some embodiments, terminal enclosure platform 106 comprises multiple parts that are coupled to other parts of antenna 100, including radome 101, to enclose core antenna 102.

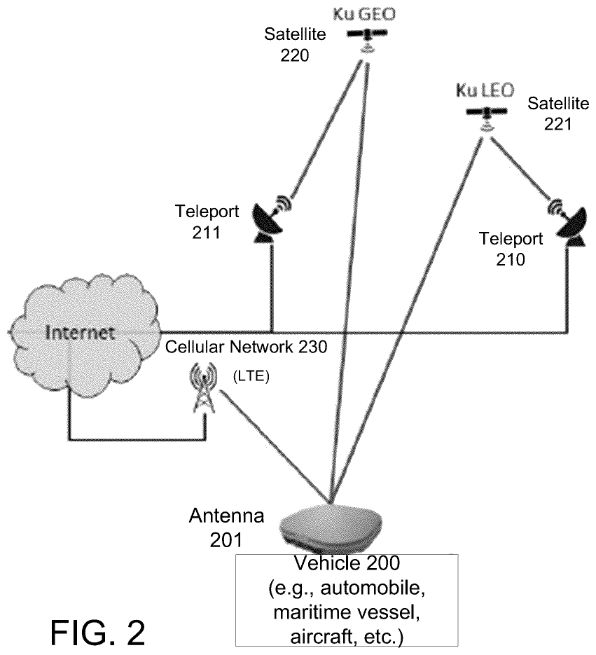

FIG. 2 illustrates an example of a communication system that includes one or more antennas described herein. Referring to FIG. 2, vehicle 200 includes an antenna 201. In some embodiments, antenna 201 comprises antenna 100 of FIG. 1.

In some embodiments, vehicle 200 may comprise any one of several vehicles, such as, for example, but not limited to, an automobile (e.g., car, truck, bus, etc.), a maritime vehicle (e.g., boat, ship, etc.), airplanes (e.g., passenger jets, military jets, small craft planes, etc.), etc. Antenna 201 may be used to communicate while vehicle 200 is either on-the-pause or moving. Antenna 201 may be used to communicate to fixed locations as well, e.g., remote industrial sites (mining, oil, and gas) and/or remote renewable energy sites (solar farms, windfarms, etc.).

In some embodiments, antenna 201 is able to communicate with one or more communication infrastructures (e.g., satellite, cellular, networks (e.g., the Internet), etc.). For example, in some embodiments, antenna 201 is able to communicate with satellites 220 (e.g., a GEO satellite) and 221 (e.g., a LEO satellite), cellular network 230 (e.g., an LTE, etc.), as well as network infrastructures (e.g., edge routers, Internet, etc.). For example, in some embodiments, antenna 201 comprises one or more satellite modems (e.g., a GEO modem, a LEO modem, etc.) to enable communication with various satellites such as satellite 220 (e.g., a GEO satellite) and satellite 221 (e.g., a LEO satellite) and one or more cellular modems to communicate with cellular network 230. For another example of an antenna communicating with one or more communication infrastructures, see U.S. patent Ser. No. 16/750,439, entitled “Multiple Aspects of Communication in a Diverse Communication Network”, and filed Jan. 23, 2020.

In some embodiments, to facilitate communication with various satellites, antenna 201 performs dynamic beam steering. In such a case, antenna 201 is able to dynamically change the direction of a beam that it generates to facilitate communication with different satellites. In some embodiments, antenna 201 includes multi-beam beam steering that allows antenna 201 to generate two or more beams at the same time, thereby enabling antenna 201 to communication with more than one satellite at the same time. Such functionality is often used when switching between satellites (e.g., performing a handover). For example, in some embodiments, antenna 201 generates and uses a first beam for communicating with satellite 220 and generates a second beam simultaneously to establish communication with satellite 221. After establishing communication with satellite 221, antenna 201 stops generating the first beam to end communication with satellite 220 while switching over to communicate with satellite 221 using the second beam. For more information on multi-beam communication, see U.S. Pat. No. 11,063,661, entitled “Beam Splitting Hand Off Systems Architecture”, issued Jul. 13, 2021.

In some embodiments, antenna 201 uses path diversity to enable a communication session that is occurring with one communication path (e.g., satellite, cellular, etc.) to continue during and after a handover with another communication path (e.g., a different satellite, a different cellular system, etc.). For example, if antenna 201 is in communication with satellite 220 and switches to satellite 221 by dynamically changing its beam direction, its session with satellite 220 is combined with the session occurring with satellite 221.

Thus, the antennas described herein may be part of a satellite terminal that enables ubiquitous communications and multiple different communication connections.

In some embodiments, antenna 201 comprises a metasurface RF antenna having multiple RF radiating antenna elements that are tuned to desired frequencies using RF antenna element drive circuitry. The drive circuitry can include a drive transistor (e.g., a thin film transistor (TFT) (e.g., CMOS, NMOS, etc.), low or high temperature polysilicon transistor, memristor, etc.), a Microelectromechanical systems (MEMS) circuit, or other circuit for driving a voltage to an RF radiating antenna element. In some embodiments, the drive circuitry comprises an active-matrix drive. In some embodiments, the frequency of each antenna element is controlled by an applied voltage. In some embodiments, this applied voltage is also stored in each antenna element (pixel circuit) until the next voltage writing cycle.

### Multi-Constellation Transceiver

Embodiments described herein include a multi-constellation transceiver. In some embodiments, the multi-constellation transceiver is included in a single satellite terminal with an antenna, such as, for example, described above. In some embodiments, the multi-constellation transceiver supports multiple modems of any orbit type (e.g., LEO, EO, GEO, etc.). In some embodiments, signals can be routed to different modems based on commands sent via the antenna to the multi-constellation transceiver. In some embodiments, the modems can use different waveforms and/or symbol rate limits.

Embodiments disclosed herein include a device that allows the directing of power to and from a common port of a satellite terminal into the correct modem by leveraging RF switchability and unique connections and RF paths to allow the flow of energy to the correct modem.

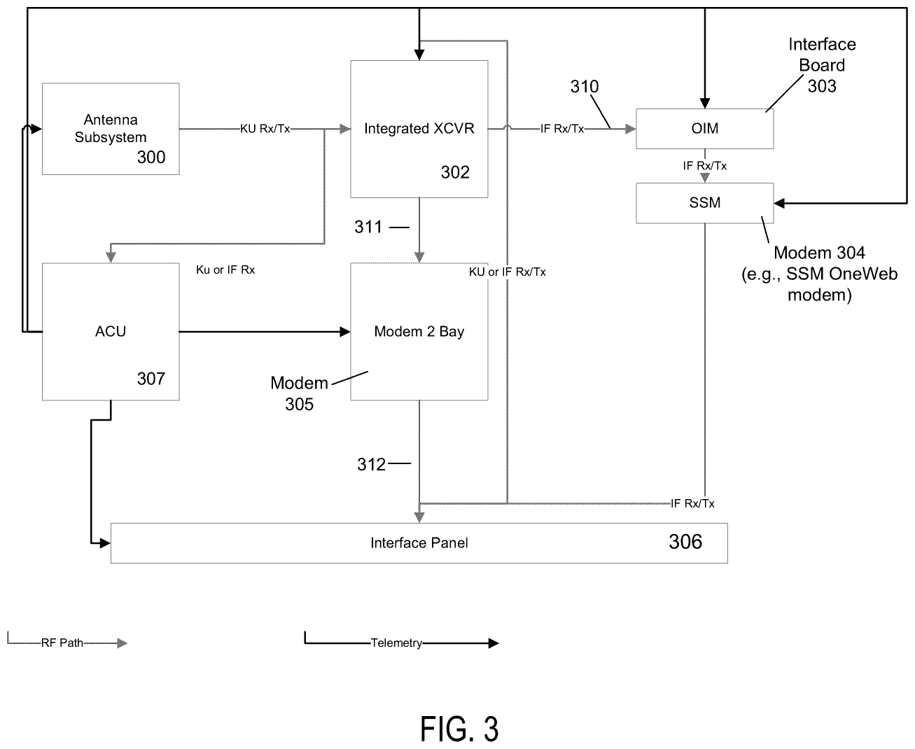

FIG. 3 illustrates some embodiments of a satellite terminal having a multi-constellation transceiver. Referring to FIG. 3, the satellite terminal includes an antenna subsystem 300 that is coupled to an integrated transceiver 302. In some embodiments, antenna subsystem 300 comprises antenna aperture, such as, for example, one of the antenna apertures with metamaterial antenna elements described above. Note that antenna subsystem 300 can comprise antenna apertures with other types of antenna elements. In some embodiments, transceiver 302 is coupled to antenna subsystem 300 via a single common port.

Transceiver 302 performs transmit and receive operations for transmit (Tx) and receive (Rx) signals for antenna subsystem 300. That is, transceiver 302 obtains Rx signals from antenna subsystem 300, via a common port, and provides them to their associated modem and receives TX signals from modems and provides them, via the common port, to antenna subsystem 300 for transmission thereby. In some embodiments, transceiver 302 includes an RF conversion module (RFC) that is used for both Tx and Rx operations for multiple modems. That is, regardless of the modem being used, transceiver 302 includes an RFC that contains portions that are shared between a transmit signal path for transmitting signals using antenna subsystem 300 and a receive signal for receiving signals from antenna subsystem 300. The sharing of the RF chain between multiple modems is beneficial in that it reduces the amount of hardware needed to perform the transmit and receive operations for multiple modems and can help reduce loss and noise. For example, when leveraging the same low-noise amplifier (LNA) and high pass amplifier (HPA) in an RF chain used by multiple modems, the noise figure is preserved by minimizing loss on the front end and any componentry required to accommodate switching between different modems exists after the high gain amplifiers.

Transceiver 302 is coupled to each of modems 304 and 305 via signal path 310 and 311, respectively. In some embodiments, transceiver 302 is coupled to modem 304 via a modem interface board 303. In some embodiments, during receive (Rx), transceiver 302 provides an intermediate frequency (IF) Rx/Tx signal on signal path 310 to modem 304 via LEO interface board 303. In some embodiments, modem 305 can be part of a modem bay with other modems (e.g., another GEO modem, a MEO modem, etc.) that are in the multi-transceiver with modem 304.

In some embodiments, modems 304 and 305 are coupled to interface panel 306, which is operable to act as an external interface for the satellite terminal of FIG. 3. Communications can occur from external sources to modems 304 and 305, via interface panel 306. In some embodiments, another signal path 312 transfers signals to interface panel 306. In some embodiments, these signals are related to KU band or an IF Rx/Tx. In some embodiments, signal path 312 can be used to provide status of the modem operation at the interface panel or can be an RF or IF path that allows an external modem to use the integrated transceiver.

An antenna control unit (ACU) 307 is also coupled to antenna subsystem 300, integrated transceiver 302, interface board 303, modem 304, and modem 305. In some embodiments, ACU 307 is coupled to these components with telemetry signals that transfer control, status, and data signals.

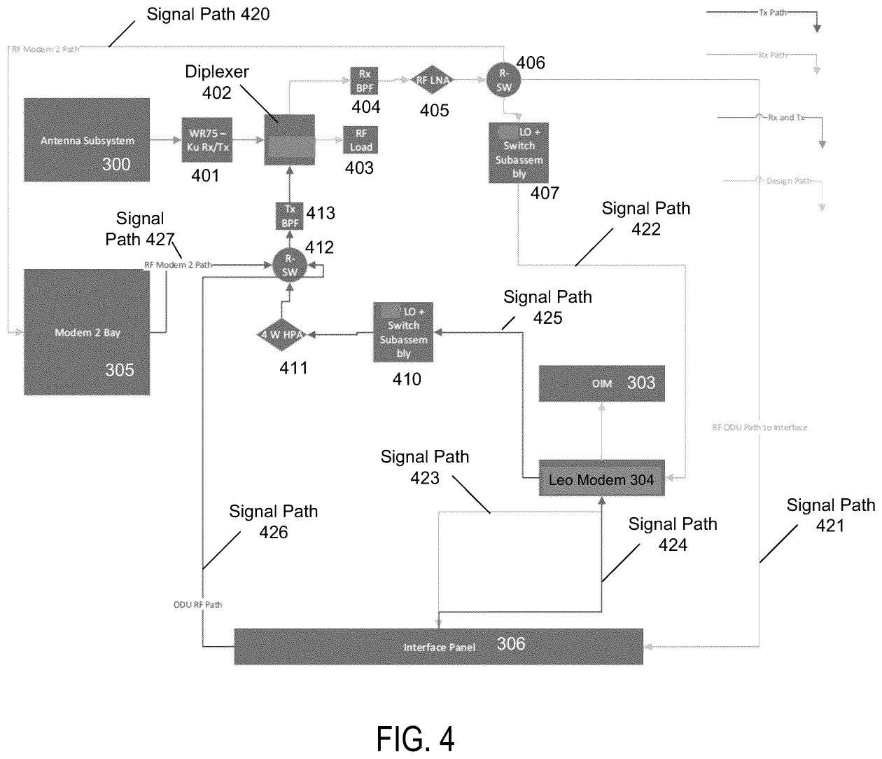

FIG. 4 illustrates some embodiments of the satellite terminal of FIG. 3. Referring to FIG. 4, antenna subsystem 300 is coupled to a common port 401. In some embodiments, port 401 comprises a WR75-KU Rx/Tx port. Common port 401 is coupled to diplexer 402. Diplexer 402 operates as a three way port such that energy is only transferred in one direction. RF load 403 is coupled to isolator 402 to make sure reflections go into RF load 403 and not into common port 401.

Diplexer 402 separates out the receive (Rx) and transmit (Tx) paths. During receive, a received signal goes from duplexor 402 to Rx bandpass filter (BPF) 404 that filters out the received signal and rejects transmits signals and interference from the received signal. After filtering, an RF low noise amplifier (LNA) 405 amplifies the signal. The amplified received signal then goes through a switch 406 that provides the signal, or portion thereof, to modem 305 via signal path 420, to interface panel 306 via signal path 421, or to modem 304 via signal path 422. Signal path 421 represents an RF outdoor unit (ODU) path to interface panel 306 for received signals sent from switch 406. When sending a received signal to modem 304 via signal path 422, the received signal passes through LEO LO and switch subassembly 407, which performs down-conversion operations on the received signals. In some embodiments, the down conversion can consist of down converting a number of channels at different frequencies to the same IF using a different LO. From modem 304, a received signal is sent to interface panel via signal path 423.

Signals being transmitted by modems 304 and 305 are also coupled to an input of diplexer 402 for transmission to antenna subsystem 300 via common port 401. In some embodiments, transmit signals are sent from interface panel 306 to modem 304 on signal path 424, and modem 304 provides the transmit signals on signal path 425 to OW LO and switch assembly 410. Switch assembly 410 provides the transmit signal to high powered amplifier (HPA) 411 which amplifies the transmit signal. In some embodiments, HPA 411 is a 4 W high power amplifier. The amplified signals then sent to switch 412. In some embodiments, HPA 411 is controlled as part of an uplink power control process when a LEO modem is in use by the transceiver. HPA 411 can be controlled to ensure that the transmit power level does not interfere with a LEO constellation. In some embodiments, the control of the HPA 411 is performed by an ACU (e.g., ACU 107 of FIG. 1).

Switch 412 also receives transmit signals from modem 305 via signal path 427 and from the ODU RF path via interface panel 106 on signal path 426. Switch 412 is controlled to provide one of the transmit signals on its input to Tx BPF 413, which filters the signal and sends the filtered signal to the antenna subsystem 300 for transmission via diplexer 402 and common port 401.

As mentioned above, modem 305 may be one of one or more modems in a modem bay coupled to switch 412 to provide transmit signals to switch 412 and onto antenna 300 for transmission through antenna 300.

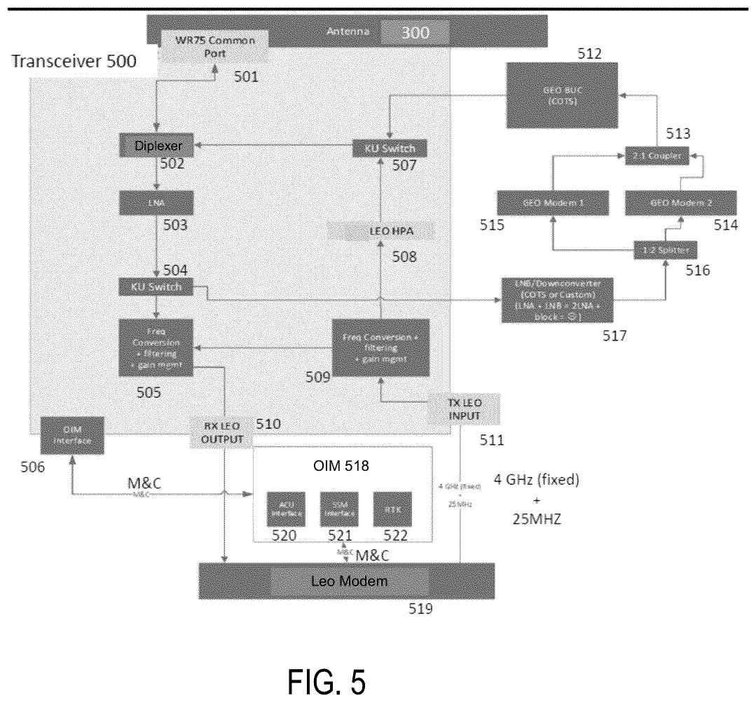

FIG. 5 illustrates a multi-constellation transceiver of a satellite terminal having an antenna. In some embodiments, also, the modems leverage portions of the RF front-end, thereby removing hardware costs and complexities. Also, in some embodiments, the multi-constellation transceiver includes a separate port to allow a band (e.g., the KU band) to be ported to a modem external to the transceiver.

Referring to FIG. 5, the components include a common port 501 (e.g., a WR75 common port) coupling an antenna subsystem 300 to the transceiver. Common port 501 is also coupled to one port of isolator/diplexer 502. Another port of isolator/diplexer 502 is coupled to send signals received by antenna 300 to a low noise amplifier (LNA) 503, which amplifies received signals. The output of LNA 503 is coupled to one input of switch 504. In some embodiments, switch 504 provides a signal, or portion thereof, to signal processor 505, which performs frequency conversion, filtering, and gain management on received signals and then outputs received signals, via RX LEO output port 510, to a first modem 519.

Switch 504 can tap off a received signal towards another modem and transmission path for processing. In some embodiments, this process includes a low-noise block downconverter (LNB)/downconverter 517 performing low-noise block down conversion and a 1:2 splitter 516 which performs 1-to-2 signal splitting. Splitter 516 sends a portion of the signal to GEO modem 514 and another portion of the signal to GEO modem 515, where the received signals can thereafter be verified via the modem and return signals may be transmitted via antenna 300 or sent via the ODU of the terminal. In some embodiments, switch 504 is a KU switch and taps off a KU signal and sends it toward a GEO transmission path. Using switch 504 to tap off a signal towards the GEO transmission path enables a separate GEO module to be coupled to the multi-constellation transceiver to provide GEO modem functionality as a separate module.

Switch 504 provides received signals to signal processor 505 to undergo frequency conversion, filtering, and gain management. Thereafter, the received signal outputs to modem 519 via Rx LEO output port 510 to modem 519.

In some embodiments, a first modem (e.g., LEO) interface board (OIM) 518 includes an ACU interface 520 to interface modem 519 to the ACU (e.g., ACU 307 of FIG. 3), a modem interface 521 to interface modem 519 (e.g., an interface to a LEO modem) to the transceiver and other terminal components, and a real-time kinematic positioning (RTK) system 522. OIM 518 is coupled to the transceiver via OIM interface 506 to provide monitoring and control for modem 519 via interface board at 518.

During transmit, signals for transmission may come from modem 519 or GEO modems 514 and 515. In the case of modem 519, transmit signals are sent from modem 519 to a transmit LEO input port 511 and onto signal processor 509. Signal processor 509 performs frequency division, filtering, and gain management on the transmit signals. Afterwards, HPA 508 amplifies the transmit signals. In some embodiments, HPA 508 is a 4 W LEO high-powered amplifier. The amplified transmit signals then proceeds to KU switch 507, which provides the signal to isolator/duplexer 502 and then onto antenna 300 via common port 501 for transmission.

When transmitting signals from GEO modems 514 and 515, GEO modems 514 and 515 send transmit signals to 2:1 coupler 513 which combines the signals and provides them to a GEO block upconverter (BUC) 512 which performs up conversion on the transmit signals and provides the upconverted signal to switch 507 (e.g., a KU switch). In some embodiments, as one modem will be operating at a time, the 2:1 coupler allows both modems to communicate on a single line without an active switch. From there, the transmit signals proceed through isolator/duplexer 502 and common port 501 to be transmitted via antenna subsystem 300.

Thus, the transceiver of FIG. 5 includes multiple modems that transmit and receive signals of multiple constellations (e.g., LEO, GEO, etc.) while sharing the RF front end. By sharing the RF front end, the cost to support two constellation transmit/receive paths is reduced.

Another benefit to this design is that the transceiver may be designed for a throughput/network that requires lower EIRP. If a second modem is required and requires a higher EIRP (e.g., a GEO network), rather than redesigning the transceiver, the additional hardware can be included at no extra burden to the transceiver/primary modem.

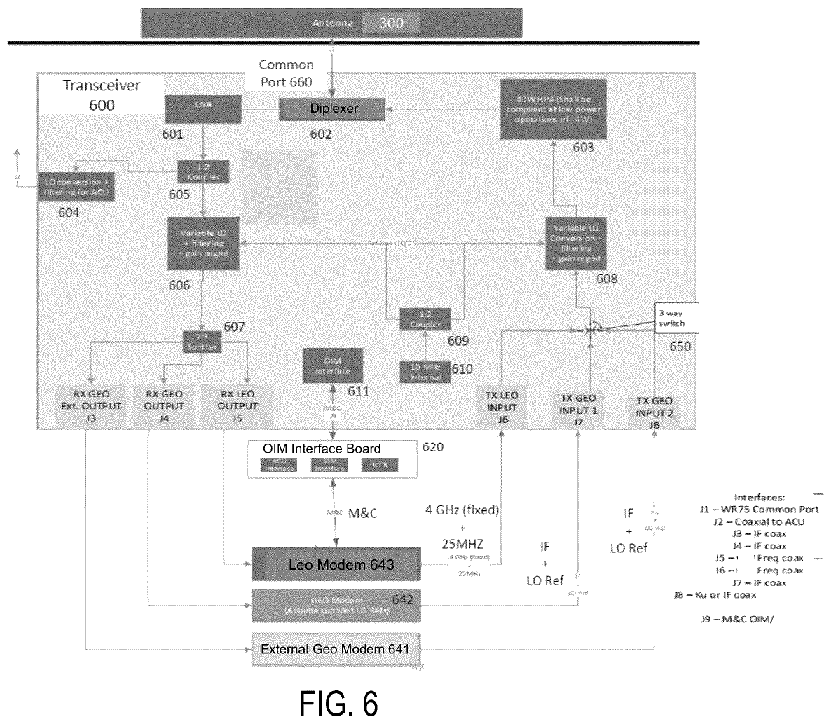

FIG. 6 illustrates some embodiments of a fully-enclosed three modem transceiver. In this embodiment, the transceiver also includes a coupler post low noise amplifier (LNA) to allow a “clean” signal to be sent to the antenna control unit (ACU) for pointing and tracking rather than routing the whole receive (Rx) signal through the terminal. Certain modems have different intermediate frequency (IF) bands. Removing the Rx path through the ACU allow for non-standard modem bands to not require a down conversion to IF and then another conversion back up to the modem frequency. In some embodiments, certain ports perform a local oscillator (LO) translation of a conventional LNB (e.g., 9.75/10.6 GHz) to ensure that no matter which service provider is in use, the frequency will always be correct for pointing and tracking, while also ensuring the highest quality signal to and from the modem. This could also remove hardware and complexity associated with the internals to the antenna. In some embodiments, a programmable LO is used. Leveraging a programmable LO allows for multiple translations using a single piece of hardware, thereby allowing more modularity in the future.

In some embodiments, the transceiver comprises a single hardware assembly that combines the conventional LNB/BUC/diplexer of a satellite terminal and introduces routing that may be leveraged for ESAs due to the ability to quickly repoint to a new satellite. In some embodiments, hardware connects the antenna and the modems, and includes all filtering, amplification, and translations to convert from a satellite Ku band to the required modem frequency and power.

The transceiver of FIG. 6 includes a number of components. These includes a LNA 601, a diplexer/isolator (plus filter) 602, a HPA 603 (e.g., 40 W HPA), local oscillator (LO) conversion and filtering module 604 (for ACU), 1:2 coupler 605, variable LO, filtering and gain management device 606, 1:3 splitter 607, variable LO conversion, filtering and gain management device 608, 1:2 coupler 609, 10 MHz Internal clock 610, OIM interface 611, modem (e.g., a LEO modem) interface board (OIM) with ACU interface, modem interface (e.g., LEO modem interface), and RTK 620.

Referring to FIG. 6, during Rx, signals received by antenna subsystem 300 proceeds through a common port to integrated transceiver 600. More specifically, received signals from antenna subsystem 300 proceeds to diplexer/isolator 602 via common port. In some embodiments, the port is a KU WR75 common port. In some embodiments, diplexer/isolator 602 includes a filter to performing filtering of receive signal. Diplexer/isolator 602 provides the received signals to LNA 601 after any filtering is performed. LNA 601 amplifies received signals and provides the amplified signals to 1:2 coupler 605 which splits the signals and sends signals toward both the ACU, such as ACU 107 on FIG. 1, and to variable LO, filtering, and gain management device 606, which down converts and filters the received signal. In some embodiments the coupled signal when it's sent towards the ACU undergoes LO conversion and filtering for the ACU 604.

The portion of the signal provided from coupler 605 to variable LO conversion undergoes variable LO conversion, filtering, and gain management at block 606. After conversion, the signal is provided to a 1:3 splitter 607 splits the received signals to three different output ports. Two of the output of 1:3 splitter 607 are receive GEO output ports J3 and J4, while the third output port is an Rx LEO output port J5. Each of output ports J3-J5 are sent to different modems. The received signals from the Rx GEO output port are sent to external GEO modem 641. The received signals from GEO output port J4 are sent to a GEO modem 642, and the received signals from the RX LEO output port J5 are sent to a LEO modem 643.

In some embodiments, the LEO modem 643 also interfaces to transceiver 600 via OIM board 620. In some embodiments, OIM board 620 includes an ACU interface for interfacing to an ACU, such as ACU 507 in FIG. 5. In some embodiments, OIM interface board 620 includes an ACU interface used by the ACU to command the OIM interface 620 to have the multi-transceiver operate in LEO mode (i.e., using the LEO modem) or GEO mode (i.e., using the GEO modem). Note that, in some embodiments, the switch between LEO and GEO modes includes a polarization change in antenna. More specifically, when switching between GEO and LEO, the antenna switches between linear polarization (typical for GEO) and circular polarization (typical for LEO), and vice versa. This generally cannot be performed with a parabolic antenna due to physical hardware limitations.

OIM board 620 also includes a modem interface to interfacing modem 643 and an RTK. OIM board 620 interfaces with transceiver 600 via an OIM interface 611. In some embodiments, the switch to different LOs, both to support different constellations or to provide different LOs for different channels in LEO mode is accomplished using a programmable LO that support multiple translations. In some embodiments, the programmable LO is controlled by the ACU in response to commands from the LEO mode via the OIM interface board 620 and OIM interface 611.

During Tx, transmit signals from modems 641 to 643 are sent to integrated transceiver 600 via different ports. More specifically, transmit signals from modem 643 are provided to transmit LEO input port J6, transmit signals from GEO modem 642 are provided to transmit GEO input port J7, and GEO transmit signals from external GEO modem 641 are provided to transmit GEO input port J8.

Transmit signals from each of the transmit input ports J6-J8 are coupled to a three way switch 650 which provides transmit signals to device 608 that provides variable LO conversion, filtering and gain management and provides the processed signal to a HPA 603 for amplification. In some embodiments, HPA 603 comprises a 40 W high-power amplifier. The amplified signal from high powered amplifier 603 is sent to diplexer/isolator 602 which provides the signal to antenna subsystem 300 via a common port for transmission by antenna subsystem 300.

In some embodiments, between 1:3 splitter 607 and Rx output ports J3-J5, downconverter assemblies perform down conversion to the modem receive frequency, and the signal paths between Tx input ports J6-J8 include upconverters to perform frequency up-conversion on the frequency of the transmit signals to adjust the transmit signals for the frequency of the constellation.

In some other embodiments, the terminal can include multiple different alternatives such as, for example, a different set of modems, high power amplifier (HPA) power, routing logic, and interfaces to components which interact with the multi-constellation transceiver. Any design of hardware that converts the satellite signal to the desired operating parameters of the modem may be used, this includes all satellite frequency bands including but not limited to C, KU, KA, X, Q-bands, etc.

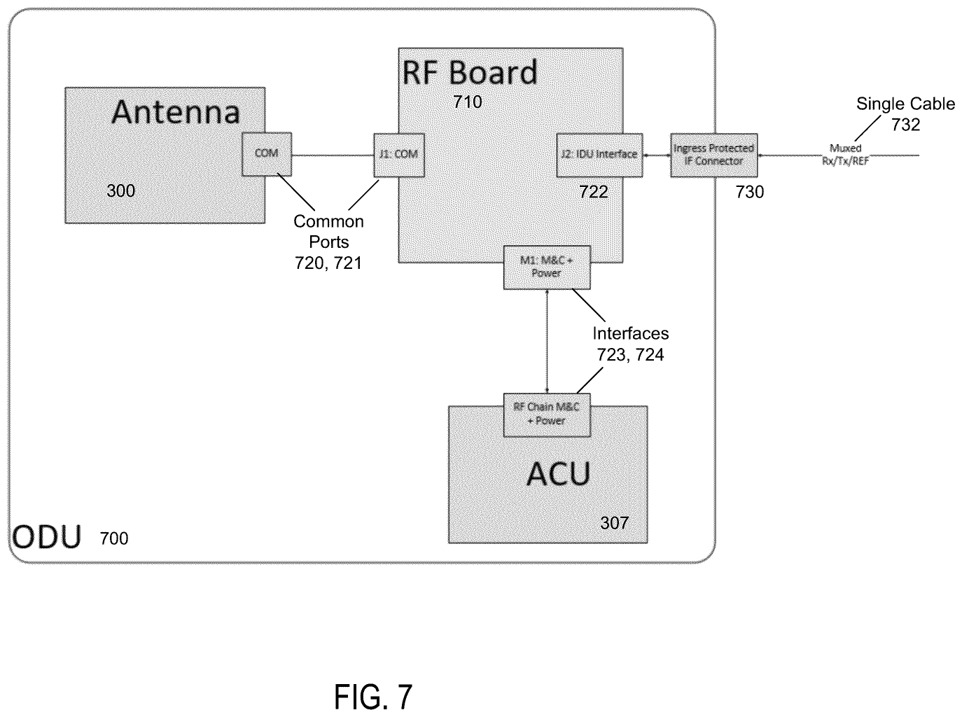

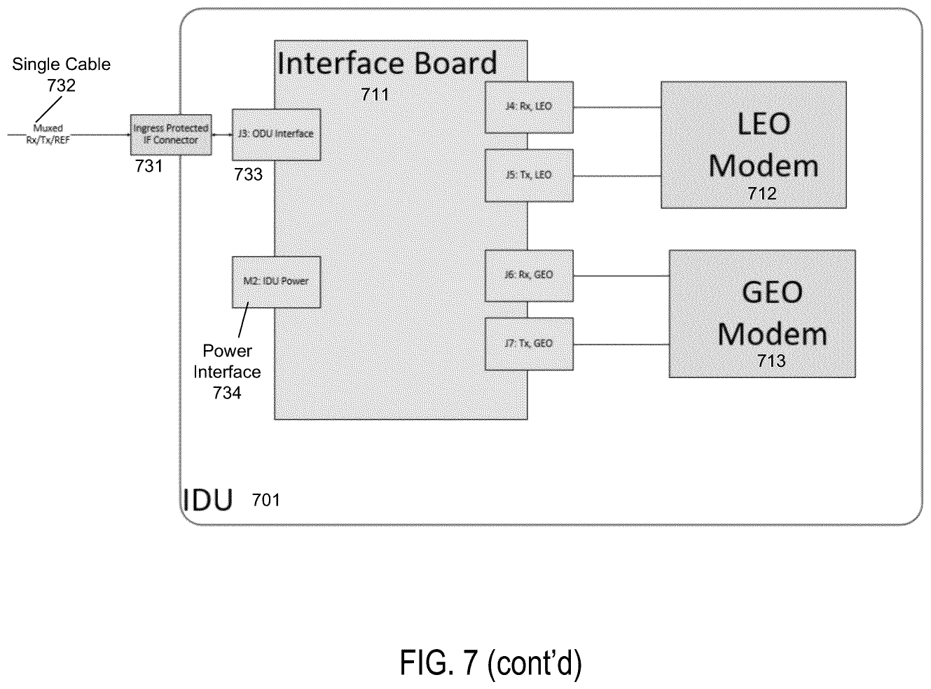

As shown in FIG. 6, modems interface to the transceiver via six external ports. In some embodiments, these ports can be reduced to two using a single cable. FIG. 7 illustrates some embodiments of a multi-conflation transceiver that use a single cable with two ports to replace the six external ports of FIG. 6. In FIG. 7, an outdoor unit (ODU) 700 is coupled via cable 732 to indoor unit (IDU) 701. In one embodiment, cable 732 is a single cable that couples the RF chain of ODU 700 to the modems of IDU 701.

In one embodiment, ODU 700 includes the antenna subsystem 300 coupled to an RF board 710 via common ports 720 and 721. RF board 710 includes an IDU interface 722 that couples to IDU 701 via an ingress protected IF connector 730, common cable 732 and ingress protected IF connector 731. ACU 307 is also coupled to RF board 710 via monitoring and control interfaces, as well as power interfaces.

IDU 701 includes interface board 711 and is coupled to a LEO modem 712 and GEO modem 713. Interface board 711 is coupled to ODU 700 via ODU interface 733 and ingress protected RF connector 731, and cable 732. Interface board 711 also includes a power interface 734. Interface board 711 is coupled to LEO modem 712 via Rx output port J4 and Tx LEO input port J5. Similarly, GEO modem 713 is coupled to interface board 711 via GEO Rx output port J6 and GEO Tx input port J7.

In one embodiment, RF board 710 includes an RF chain and interface board 711 includes switches and filtering for extracting received signals sent from the RF chain via single cable 732 or combining transmit signals to be sent over single cable 732 for transmission by the RF chain and antenna 300. To that end, interface board 711 operates as an orchestration unit between the modems and the RF chain.

In some embodiments, an ACU (e.g., ACU 307, etc.) is coupled via monitoring and control (M&C) to RF board 710 via interfaces 723 and 724.

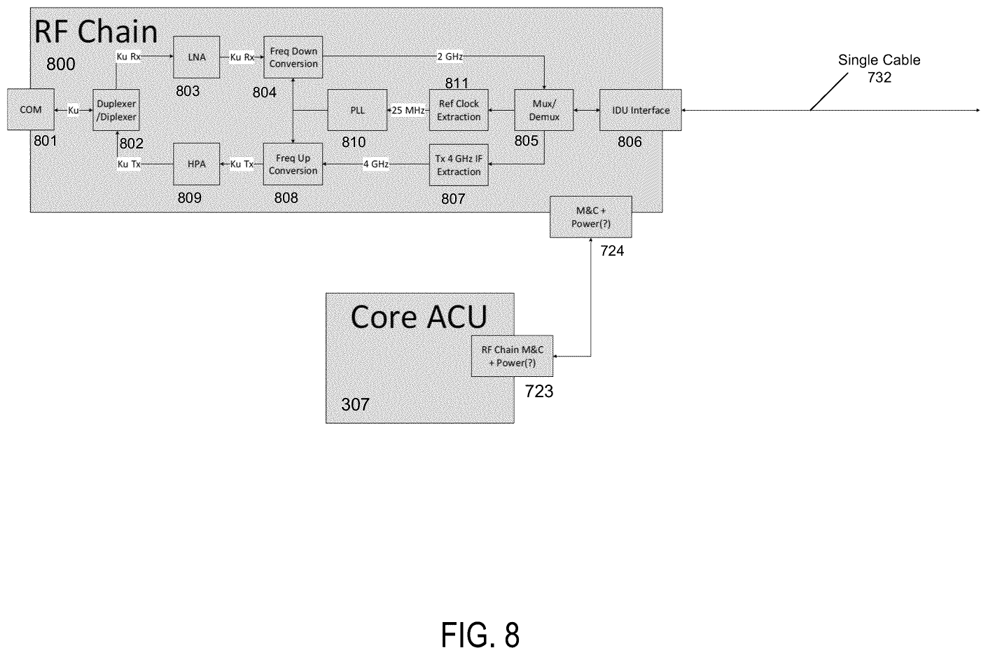

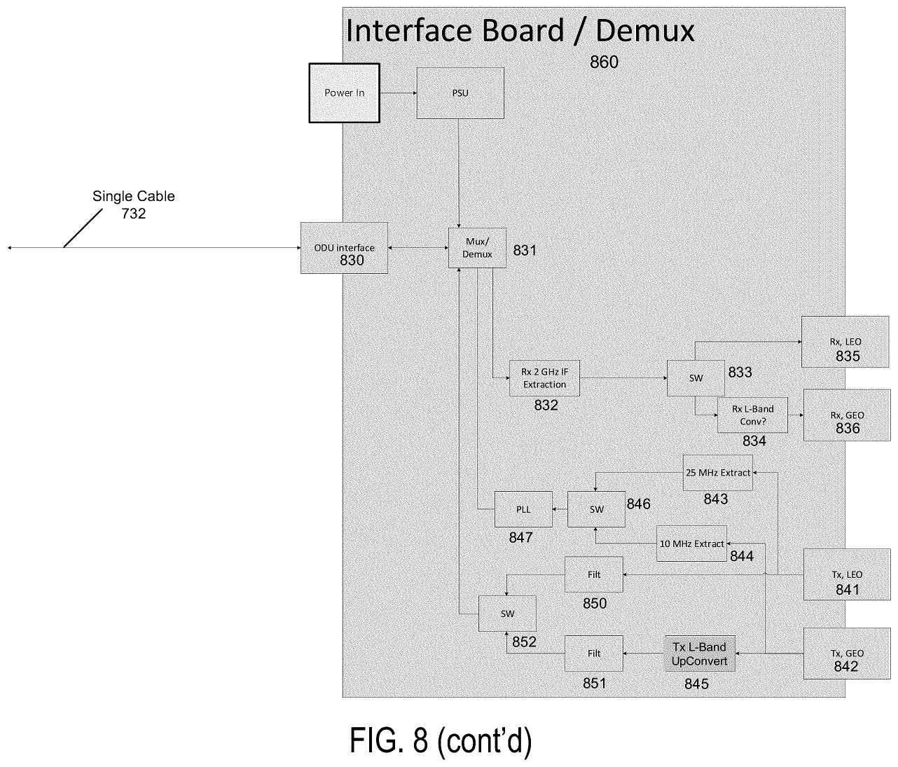

FIG. 8 illustrates some embodiments of the RF chain (conversion module) and the interface board that are coupled together via the single cable as shown in FIG. 7. The transceiver of FIG. 8 uses the single cable with multiplexing/demultiplexing on both sides of the cable to reduce the cables between the ODU where the RF chain lives and the IDU that is communicably coupled to multiple modems. This results in only a single entry point for all modems into the transceiver as opposed to two ports for each of the modems to support transmit and receive signals.

Referring to FIG. 8, RF chain 800 includes common port 801 that coupled to duplexer/diplexer 802. A received signal enters common port 801 from the antenna subsystem, such as antenna subsystem 301 of FIG. 3, and is sent from duplexer/diplexer 802 to LNA 803 which amplifies the signal and sends it to frequency down conversion unit 804, which performs frequency down conversion based on the clock's signal from phased lock loop (PLL) 810 (based on reference clock signal 811). After frequency down conversion, the signal is multiplexed for output to IDU interface 806 and single cable 732 via multiplexer (mux)/demultiplexer (demux) 805.

During transmit, a transmit signal is received by mux/demux 805 from single cable 732 via IDU interface 806. Mux/demux 805 sends a signal to Tx IF Extraction filter 807 that filters the signal and then sends it to frequency up conversion block 808 for frequency up conversion. After frequency up conversion, the signal is amplified using HPA 809 and sent to duplexer/diplexer 802, which forwards the signal, via common port 801, to the antenna subsystem for transmit by the antenna. In some embodiments, HPA 809 is controlled to limit its power while operating in LEO mode as opposed to when operating in GEO mode. The control is performed as part of uplink power control and ensures that HPA 809 is controlled to limit power to an acceptable level for the LEO constellation.

In some embodiments, the reference clock is 25 MHz while the Tx IF Extraction filter 807 operates as a narrowband filter to produce a 4 GHz signal, which is upconverted to a Ku Tx signal and the Ku Rx signal output from LNA 803 is down converted to a 2 GHz frequency. Thus, there are two separate frequency conversion stages with different LO paths. This arrangement enables having KU signals into and out of duplexer/diplexer 802.

With interface board/demultiplexer 860, when a receive signal is included in single cable 732, the signal is received by mux/demux 831 via ODU interface 830. The receive signal is extracted from cable 732 via the demux function of mux/demux 831, further isolated via filter 832, and sent to switch 833. Switch 833 is controlled to provide the received signal to a LEO modem via receive Rx LEO output port 835 or to a GEO modem via Rx GEO output port 836. In some embodiments, the path between switch 833 and receive GEO output port 836 may include a receive band conversion 834 to accommodate mismatches in modem IFs. Such a conversion may include a receive L-band conversion in which the signal is converted to a portion of the L-band compatible with the Rx GEO modem connected at Rx GEO output port 836.

For processing transmit signals on interface board/demultiplexer 860, LEO and GEO transmit signals can be received by LEO transmit input port 841 and GEO transmit input port 842, respectively. The received LEO transmit signals are sent to filter 843 and filter 850, while the GEO transmit signals are sent to filter 844 and transmit L-band up conversion 845. Filter 843 isolates the reference clock used to discipline the PLL 847 and provides it to switch 846. In some embodiment, filter 843 extracts a 25 MHz signal and sends it to switch 846. The GEO reference clock signal undergoes filtering at filter 844 and the isolated clock reference is provided to switch 846. In some embodiments, filter 844 is a 10 MHz narrow bandpass filter. Switch 846 is then controlled to provide either the LEO or GEO reference clock signals from filters 843 and 844, respectively, to mux/demux 831 via PLL 847 in order to provide a clean clock after reference clock extractions. More specifically, whatever clock is passed in will discipline the PLL 847, which in turn will get muxed and passed up to the ODU to subsequently get demuxed and discipline PLL 810, which ultimately generates the LO for any frequency conversions. Also, in some embodiments, PLL 847 controls the frequency of the reference clock to be muxed/demuxed to manage any electromagnetic compatibility (EMC) and electromagnetic interference (EMI) or to simplify the channelizer design associated with mux/demux 831.

Similarly, the LEO transmit data carrier from Tx LEO input port 841 is filtered with filter 850 and provided to switch 852 while the Tx GEO signal undergoes transmit L-band up converter 845 and then filtering at filter 851 before being provided to switch 852. The L-band up conversion performed by converter 845 is to make the IF going into the switch 852 the same so that any muxing done at mux/demux 831 is based on set channels to facilitate practical analog implementations. That is, in some embodiments, Tx LEO modem 841 & Tx GEO modem 842 start with different IF carriers (e.g., fixed 4 GHz & variable L-Band, respectively), so this conversion is performed to align everything on the fixed (e.g., 4 GHz) channel.

Switch 852 is controlled to provide either of the GEO transmit signals or LEO transmit signals to mux/demux 831. The reference clock signals from PLL 847 and the data carriers from switch 852 are multiplexed onto the single cable 532 via ODU interface 830 and provided to RF chain 800 for transmission.

Although not shown, the interface boards of FIGS. 7 and 8 can also include one or more additional terminal interfaces. Such terminal interfaces can include an interface to an additional external modem and/or can interface signals with other portions of the terminal.

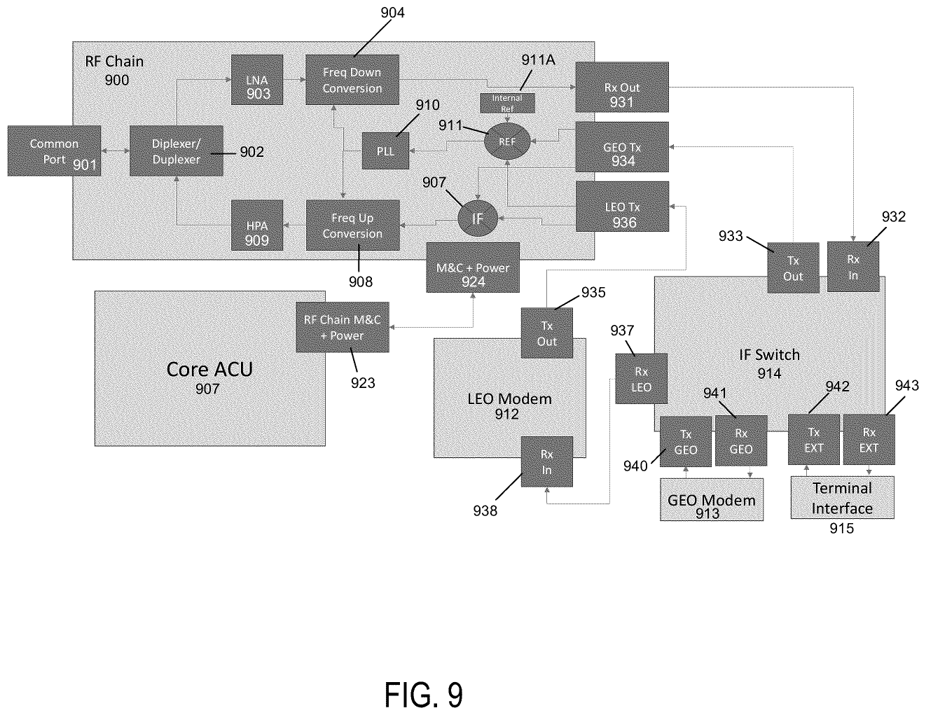

In some embodiments, there are a number of cables (e.g., coax cables) between the RF chain and the interface board instead of the single cable of FIG. 8. FIG. 9 illustrates some embodiments of the RF chain and the interface board that are coupled together via three cables (e.g., coax cables). In such a case, the transceiver of does not include multiplexing/demultiplexing on both sides of each cable as in the case of the single cable of FIG. 8.

Referring to FIG. 9, RF chain (conversion module) 900 includes common port 901 that coupled to diplexer/duplexer 902. A received signal enters common port 901 from the antenna subsystem, such as, for example, antenna subsystem 301 of FIG. 3, and is sent from duplexer/diplexer 902 to LNA 903 which amplifies the signal and sends it to frequency down conversion unit 904, which performs frequency down conversion based on the clock's signal from phased lock loop (PLL) 910 (based on reference clock signal 911 created with internal referenced 911A). In some embodiments, PLL 910 operates in the same manner as PLL 810 described above. After frequency down conversion, the signal is multiplexed for output to IF switch/interface board 914 via Rx output port 931.

During transmit, a transmit signal can be input to RF chain 900 via GEO input port 934 or LEO input port 936. In some embodiments, a GEO Tx signal being received by GEO Tx input port is received from GEO output port 933 of IF switch 914 via GEO modem 913 and GEO Tx input port 940 coupled to GEO modem 913 and terminal interface 915 and Tx input port 942 coupled to terminal interface 915.

Transmit signals received by either GEO Tx input port 934 or LEO TX input port 936 are input into Tx IF extraction filter 907 that filters the signal and then sends it to frequency up conversion block 908 for frequency up conversion. After frequency up conversion, the signal is amplified using HPA 909 and sent to diplexer/duplexer 902, which forwards the signal, via common port 901, to the antenna subsystem for transmit by the antenna. In some embodiments, HPA 909 is controlled to limit its power while operating in LEO mode as opposed to when operating in GEO mode. The control is performed as part of uplink power control and ensures that HPA 909 is controlled to limit power to an acceptable level for the LEO constellation. In some other embodiments, HPA 909 is controlled to limit its power in LEO mode and in GEO mode.

In some embodiments, the reference clock is 25 MHz while the Tx IF Extraction filter 907 operates as a narrowband filter to produce a 4 GHz signal, which is upconverted to a Ku Tx signal and the Ku Rx signal output from LNA 903 is down converted to a 2 GHz frequency. Thus, there are two separate frequency conversion stages with different LO paths. This arrangement enables having KU signals into and out of diplexer/duplexer 902.

In some embodiments, RF chain 900 also includes filters (e.g., BPFs) and switching internal to the LEO and GEO, such as described above. These components can be part of frequency down conversion unit 904 and frequency up conversion unit 908.

IF switch 914 supplies GEO Tx signals to RF chain 900, while LEO transmit signals are received by RF chain 900 directly from LEO modem 912. In contrast, received signals from RF chain 900 for both LEO modem 912 and GEO modem 913 (and potentially a third modem coupled to terminal interface 915) are received by Rx input port 932 of IF switch 914. IF switch 914 includes demultiplexing, switching and filtering to separate the received signals for the respective modems from each other and provide them to their respective modems. The LEO Rx signals are provided to LEO modem 912 via Rx output port 937 of IF switch 914 and Rx input port 938 of LEO modem 912, while the GEO Rx signals are provided to GEO modem 913 via Rx output port 941 of IF switch 914. Other received signals can be provided to terminal interface 915 via Rx output port 943 of IF switch 914.

In some embodiments, an ACU 977 (e.g., ACU 307, etc.) is coupled via monitoring and control (M&C) signals to RF chain 900 via a single cable between interface 923 of ACU 977 and interface 924 of RF chain 900.

The arrangements described above with multiple modems can be used to facilitate communications in times when failures occur in communications with one or more communications networks. For example, using handovers, if the satellite terminal is communication with a high bandwidth LEO constellation using its LEO modem, and there is a failure, then the satellite terminal can automatically transition to using the GEO modem. Subsequently, if a failure occurs in communicating with the GEO constellation, and transition back to communicating with the LEO constellation is not possible, then the satellite terminal can automatically transition to using other communication functionality (e.g., radio, cellular communication, etc.) to communication and ultimately to automatically transition to using land line or cable-based communication. In this manner, the handovers and automatic transitioning between the multiple forms of available communication enable the satellite terminal to always remain in communication.

In some embodiments, the multi-constellation transceiver operates in either GEO mode or LEO mode at any one time, and the ACU controls the multi-constellation transceiver to switch between the two modes. The ACU control can be performed using the monitoring and control signals (e.g., telemetry signals in FIG. 3, etc.). In some embodiments, the ACU switches between the two modes by, in part, setting and/or sending signals in the multi-constellation transceiver to control switches in the multi-constellation transceiver, including switches that enable signals to proceed to the modems in the receive signal path and to proceed on the transmit path from the ports of the multi-constellation transceiver receiving the signals from the modems for transmission (e.g., switches in FIGS. 5, 6, 8, including, but not limited to, splitters (e.g., splitter 407, etc.), Ku switches, etc. In some embodiments, the ACU sets up the multi-constellation transceiver to use the proper LOs for the LEO or GEO modes. In some embodiments, the ACU can work with the OIM to set the proper LOs for the LEO mode. In such a case, the LEO modem communicates with the multi-constellation transceiver using an OIM interface to tune the multi-constellation transceiver for processing receive and transmit signals in the LEO mode, as the LEO modem using a different LO per channel and changes LOs via a command from the LEO modem.

There are a number of example embodiments described herein.

Example 1 is a satellite terminal comprising: an antenna; a common port coupled to the antenna; a plurality of modems to be switched into and out of use in real-time, via software commands, to allow transitioning between networks via software commands, each of the modems associated with a different satellite constellation; and a multi-constellation transceiver, communicably coupled to the antenna via the common port and to the plurality of modems, to route signals between the antenna and individual modems of the plurality of modems.

Example 2 is the satellite terminal of example 1 that may optionally include that the multi-constellation transceiver comprises: a radio-frequency (RF) conversion module; and an interface coupled to the RF conversion module via a single communication cable, the interface configured to perform multiplexing and demultiplexing operations between the single communication cable and the plurality of modems.

Example 3 is the satellite terminal of example 2 that may optionally include that the RF chain comprises low-noise and high power amplifiers that are shared by the plurality of modems to apply amplification to signals from all modems to be transmitted by the antenna and to signals received by the antenna to be sent to the plurality of modems.

Example 4 is the satellite terminal of example 2 that may optionally include that a receive path for processing signals received by the antenna; a transmit path for processing signals to be transmitted by the antenna; and a diplexer/isolator communicably coupling the receive path and the transmit path to the common port.

Example 5 is the satellite terminal of example 2 that may optionally include that the interface comprises: a multiplexer/demultiplexer coupled to a single communication cable; a receive filter coupled to the multiplexer/demultiplexer to filter a first signal received from the multiplexer/demultiplexer; a first switch coupled to the receive filter to send the first signal to either a first or second modem of the plurality of modems based on control of the first switch; an upconverter coupled to receive a first transmit signal from the first modem; a first transmit filter coupled to receive the first transmit signal from the first modem; a second transmit filter coupled to receive a second transmit signal from the second modem; a second switch coupled to receive a first filtered signal from the downconverter and the second transmit signal and to provide the first filtered signal or the second transmit signal to the multiplexer/demultiplexer based on control of the second switch; and a third switch coupled to receive a second filtered signal from the first transmit filter and a third filtered signal from the second transmit filter and to provide the second filtered signal or the third transmit signal to the multiplexer/demultiplexer based on control of the third switch.

Example 6 is the satellite terminal of example 1 that may optionally include that the plurality of modems comprises at least one LEO modem and at least one GEO modem.

Example 7 is the satellite terminal of example 6 that may optionally include an antenna control unit (ACU) coupled to send one or more commands to the multi-constellation transceiver to switch between a LEO and GEO modes that use LEO and GEO modems, respectively, the one or more commands to limit transmit power as part of uplink power control during both the LEO and GEO modes, and program one or more local oscillators to support different translations associated with the LEO and GEO modes.

Example 8 is the satellite terminal of example 6 that may optionally include that the plurality of modems includes at least one EO modem.

Example 9 is the satellite terminal of example 1 that may optionally include that the multi-constellation transceiver comprises: a first modem; a second modem; a radio-frequency (RF) conversion module; and an interface in electronic communication with the RF conversion module to transfer receive signals received into RF conversion module via the common port to the interface, to transfer transmit signals of the first modem from the interface to the RF conversion module, and to transfer transmit signals of the second modem from the second modem to the RF conversion module without proceeding through interface, wherein the interface provides receive signals of a modem of a selected constellations in response to receiving the receive signals of the modem.

Example 10 is the satellite terminal of example 1 that may optionally include that modems of the plurality of modems are coupled to the transceiver via external ports.

Example 11 is a satellite terminal comprising: an antenna; a common port coupled to the antenna; a plurality of modems to be switched into and out of use in real-time to allow transitioning between networks via software commands, each of the modems associated with a different satellite constellation, wherein the plurality of modems comprises at least one LEO modem and at least one GEO modem; a multi-constellation transceiver, communicably coupled to the antenna via the common port and to the plurality of modems, to route signals between the antenna and to one modem of the plurality of modems, wherein the multi-constellation transceiver comprises a radio-frequency (RF) chain; and an interface coupled to the RF chain via at least one communication cable, the interface configured to perform multiplexing and demultiplexing operations between the communication cable and the plurality of modems.

Example 12 is the satellite terminal of example 11 that may optionally include that the RF chain comprises low-noise and high power amplifiers are shared by the plurality of modems to apply amplification to signals for all modems to be transmitted by the antenna and to signals received by the antenna to be sent to the plurality of modems.

Example 13 is the satellite terminal of example 11 that may optionally include a receive path for processing signals received by the antenna; a transmit path for processing signal to be transmitted by the antenna; and a diplexer communicably coupling the receive path and the transmit path to the common port.

Example 14 is the satellite terminal of example 11 that may optionally include that the interface comprises: a multiplexer/demultiplexer coupled to the communication cable; a receive filter coupled to the multiplexer/demultiplexer to filter a first signal received from the multiplexer/demultiplexer; a first switch coupled to the receive filter to send the first signal to either a first or second modem of the plurality of modems based on control of the first switch; an upconverter coupled to receive a first transmit signal from the first modem; a first transmit filter coupled to receive the first transmit signal from the first modem; a second transmit filter coupled to receive a second transmit signal from the second modem; a second switch coupled to receive a first filtered signal from the downconverter and the second transmit signal and to provide the first filtered signal or the second transmit signal to the multiplexer/demultiplexer based on control of the second switch; and a third switch coupled to receive a second filtered signal from the first transmit filter and a third filtered signal from the second transmit filter and to provide the second filtered signal or the third transmit signal to the multiplexer/demultiplexer based on control of the third switch.

Example 15 is the satellite terminal of example 11 that may optionally include an antenna control unit (ACU) coupled to send one or more commands to the multi-constellation transceiver to switch between a LEO and GEO modes that use LEO and GEO modems, respectively, the one or more commands to limit transmit power as part of uplink power control during the LEO mode, and program one or more local oscillators to support different translations associated with the LEO and GEO modes.

Example 16 is the satellite terminal of example 11 that may optionally include that the plurality of modems includes a first modem and a second modem, and further wherein the RF chain is in electronic communication with the interface to transfer receive signals received into RF conversion module via the common port to the interface, to transfer transmit signals of the first modem from the interface to the RF conversion module, and to transfer transmit signals of the second modem from the second modem to the RF conversion module without proceeding through interface, wherein the interface provides receive signals of a modem of a selected constellations in response to receiving the receive signals of the modem.

Example 17 is the satellite terminal of example 11 that may optionally include that the plurality of modems includes at least one MEO modem.

Example 18 is the satellite terminal of example 11 that may optionally include that modems of the plurality of modems are coupled to the transceiver via external ports.

Example 19 is a method comprising: switching into and out of use of the plurality of modems in real-time, via software commands, to allow transitioning between networks via software commands, each of the modems associated with a different satellite constellation; and routing signals between an antenna and individual modems of the plurality of modems an antenna by receiving signal from the antenna via a common port and directing those signals to one of the plurality of modems using a multi-constellation transceiver, communicably coupled to the antenna via the common port and to the plurality of modems; and sending transmit signals, using the multi-constellation transceiver received from the plurality of modems to the antenna via the common port.

Example 20 is the method of example 19 that may optionally include that the plurality of modems includes first and second modems, and further wherein communicating between the RF chain and the interface includes: transferring receive signals received into RF conversion module via the common port to the interface via a first cable; transferring transmit signals of the first modem from the interface to the RF conversion module via a second cable; and transfer transmit signals of the second modem from the second modem to the RF conversion module via a third cable without proceeding through interface; and sending, by the interface, receive signals of the second modem to the second modem in response to receiving the receive signals of the second modem via the first cable.

Methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions, or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware (e.g., ASICs or FPGA devices), computer software that runs on computer hardware, or combinations of both. Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the rendering techniques described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include certain features, elements, or steps. Thus, such conditional language is not generally intended to imply that features, elements, or steps are in any way required for one or more embodiments or that one or more embodiments necessarily include logic for deciding, with or without other input or prompting, whether these features, elements or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, and at least one of Z to each be present.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

We claim:

1. A satellite terminal comprising:
an antenna;
a common port coupled to the antenna;
a plurality of modems to be switched into and out of use in real-time, via software commands, to allow transitioning between networks via software commands, each of the modems associated with a different satellite constellation; and
a multi-constellation transceiver, communicably coupled to the antenna via the common port and to the plurality of modems, to route signals between the antenna and individual modems of the plurality of modems.

2. The satellite terminal of claim 1 wherein the multi-constellation transceiver comprises:
a radio-frequency (RF) conversion module; and
an interface coupled to the RF conversion module via a single communication cable, the interface configured to perform multiplexing and demultiplexing operations between the single communication cable and the plurality of modems.

3. The satellite terminal of claim 2 wherein the RF chain comprises low-noise and high power amplifiers that are shared by the plurality of modems to apply amplification to signals from all modems to be transmitted by the antenna and to signals received by the antenna to be sent to the plurality of modems.

4. The satellite terminal of claim 2 further comprising:
a receive path for processing signals received by the antenna;
a transmit path for processing signals to be transmitted by the antenna; and
a diplexer/isolator communicably coupling the receive path and the transmit path to the common port.

5. The satellite terminal of claim 2 wherein the interface comprises:
a multiplexer/demultiplexer coupled to a single communication cable;
a receive filter coupled to the multiplexer/demultiplexer to filter a first signal received from the multiplexer/demultiplexer;
a first switch coupled to the receive filter to send the first signal to either a first or second modem of the plurality of modems based on control of the first switch;
an upconverter coupled to receive a first transmit signal from the first modem;
a first transmit filter coupled to receive the first transmit signal from the first modem;
a second transmit filter coupled to receive a second transmit signal from the second modem;
a second switch coupled to receive a first filtered signal from the downconverter and the second transmit signal and to provide the first filtered signal or the second transmit signal to the multiplexer/demultiplexer based on control of the second switch; and
a third switch coupled to receive a second filtered signal from the first transmit filter and a third filtered signal from the second transmit filter and to provide the second filtered signal or the third transmit signal to the multiplexer/demultiplexer based on control of the third switch.

6. The satellite terminal of claim 1 wherein the plurality of modems comprises at least one LEO modem and at least one CEO modem.

7. The satellite terminal of claim 6 further comprising an antenna control unit (ACU) coupled to send one or more commands to the multi-constellation transceiver to switch between a LEO and GEO modes that use LEO and GEO modems, respectively, the one or more commands to
limit transmit power as part of uplink power control during both the LEO and GEO modes, and
program one or more local oscillators to support different translations associated with the LEO and GEO modes.

8. The satellite terminal of claim 6 wherein the plurality of modems includes at least one MEO modem.

9. The satellite terminal of claim 1 wherein the multi-constellation transceiver comprises:
a first modem;
a second modem;
a radio-frequency (RF) conversion module; and
an interface in electronic communication with the RE conversion module
to transfer receive signals received into RE conversion module via the common port to the interface,
to transfer transmit signals of the first modem from the interface to the RF conversion module, and
to transfer transmit signals of the second modem from the second modem to the RF conversion module without proceeding through interface,
wherein the interface provides receive signals of a modem of a selected constellations in response to receiving the receive signals of the modem.

10. The satellite terminal of claim 1 wherein modems of the plurality of modems are coupled to the transceiver via external ports.

11. A satellite terminal comprising:
an antenna;
a common port coupled to the antenna;
a plurality of modems to be switched into and out of use in real-time to allow transitioning between networks via software commands, each of the modems associated with a different satellite constellation, wherein the plurality of modems comprises at least one LEO modem and at least one GEO modem;
a multi-constellation transceiver, communicably coupled to the antenna via the common port and to the plurality of modems, to route signals between the antenna and to one modem of the plurality of modems, wherein the multi-constellation transceiver comprises:
a radio-frequency (RF) chain; and
an interface coupled to the RIF chain via at least one communication cable, the interface configured to perform multiplexing and demultiplexing operations between the communication cable and the plurality of modems.

12. The satellite terminal of claim 11 wherein the RF chain comprises low-noise and high power amplifiers are shared by the plurality of modems to apply amplification to signals for all modems to be transmitted by the antenna and to signals received by the antenna to be sent to the plurality of modems.

13. The satellite terminal of claim 11 further comprising:
a receive path for processing signals received by the antenna;
a transmit path for processing signal to be transmitted by the antenna; and
a diplexer communicably coupling the receive path and the transmit path to the common port.

14. The satellite terminal of claim 11 wherein the interface comprises:
a multiplexer/demultiplexer coupled to the communication cable;
a receive filter coupled to the multiplexer/demultiplexer to filter a first signal received from the multiplexer/demultiplexer;
a first switch coupled to the receive filter to send the first signal to either a first or second modem of the plurality of modems based on control of the first switch;
an upconverter coupled to receive a first transmit signal from the first modem;
a first transmit filter coupled to receive the first transmit signal from the first modern;
a second transmit filter coupled to receive a second transmit signal from the second modem;
a second switch coupled to receive a first filtered signal from the downconverter and the second transmit signal and to provide the first filtered signal or the second transmit signal to the multiplexer/demultiplexer based on control of the second switch; and
a third switch coupled to receive a second filtered signal from the first transmit filter and a third filtered signal from the second transmit filter and to provide the second filtered signal or the third transmit signal to the multiplexer/demultiplexer based on control of the third switch.

15. The satellite terminal of claim 11 further comprising an antenna control unit (ACU) coupled to send one or more commands to the multi-constellation transceiver to switch between a LEO and GEO modes that use LEO and GEO modems, respectively, the one or more commands to
limit transmit power as part of uplink power control during the LEO mode, and
program one or more local oscillators to support different translations associated with the LEO and GEO modes.

16. The satellite terminal of claim 11 wherein the plurality of modems includes a first modem and a second modem, and further wherein the RF chain is in electronic communication with the interface
to transfer receive signals received into RF conversion module via the common port to the interface,
to transfer transmit signals of the first modem from the interface to the RF conversion module, and
to transfer transmit signals of the second modem from the second modem to the RF conversion module without proceeding through interface,
wherein the interface provides receive signals of a modem of a selected constellations in response to receiving the receive signals of the modem.

17. The satellite terminal of claim 11 wherein the plurality of modems includes at least one MEO modem.

18. The satellite terminal of claim 11 wherein modems of the plurality of modems are coupled to the transceiver via external ports.

19. A method comprising:
switching into and out of use of the plurality of modems in real-time, via software commands, to allow transitioning between networks via software commands, each of the modems associated with a different satellite constellation; and
routing signals between an antenna and individual modems of the plurality of modems an antenna by
receiving signal from the antenna via a common port and directing those signals to one of the plurality of modems using a multi-constellation transceiver, communicably coupled to the antenna via the common port and to the plurality of modems; and
sending transmit signals, using the multi-constellation transceiver received from the plurality of modems to the antenna via the common port.

20. The method of claim 19 wherein the plurality of modems includes first and second modems, and further wherein communicating between the RF chain and the interface includes:
transferring receive signals received into RE conversion module via the common port to the interface via a first cable;
transferring transmit signals of the first modem from the interface to the RF conversion module via a second cable; and
transfer transmit signals of the second modem from the second modem to the RF conversion module via a third cable without proceeding through interface,
further comprising sending, by the interface, receive signals of the second modem to the second modem in response to receiving the receive signals of the second modem via the first cable.
